(19) United States
(12) Patent Application Publication
(10) Pub. No.: US 2026/0342575 A1
(43) Pub. Date: Oct. 29, 2026

(54) BINARY TOWER FIELD HARDWARE ACCELERATOR FOR VERIFIABLE COMPUTING

(71) Applicant: Irreducible, Inc., Miami, FL (US)

(72) Inventors: Thomas Detwiler, Huntsville, AL (US); Radisav Cojbasic, Berlin (DE); Guozhu Xin, Shanghai (CN); Danilo Sijacic, Belgrade (RS); Jiewen Sun, Miami, FL (US)

(21) Appl. No.: 19/190,681

(22) Filed: Apr. 27, 2025

(51) Int. Cl. H04L 9/32

(52) U.S. Cl. CPC H04L 9/3218

(57) ABSTRACT

Disclosed are a system and method for accelerating cryptographic computations using a binary tower field hardware accelerator. The method initiates with a step of configuring worker agents via a configuration network to perform specific computational tasks. Once configured, a data network receives elements defined over a small element field, which serve as input operands for cryptographic operations. The worker agents then execute a sequence of mathematical operations involving these elements to enable a scalable computation over binary tower fields.

### TECHNICAL FIELD

The present invention relates generally to integrated circuit architectures, and more particularly to a hardware accelerator for operations on binary tower fields, the accelerator being particularly adapted to verifiable computing applications.

### BACKGROUND OF THE INVENTION

Verifiable computing enables a computer to perform a task (such as a computation or calculation), and return the result of the task along with a cryptographic proof that the task was performed correctly. More particularly, verifiable computing techniques allow a first party to outsource the computation of an arbitrary function F to an untrusted worker. The untrusted worker then evaluates F on the provided input X, and returns both the computation of F along with a mathematical proof that enables the first party to verify that the untrusted worker's computation was carried out correctly on X. The verification of the proof should be performed efficiently (i.e., significantly faster, and requiring fewer computational resources, than re-calculating F(X) from scratch). Verifiable computing may be employed to support a variety of applications that necessitate strong guarantees of correctness—such as electronic voting and blockchains. However, proof systems that are expensive to operate (in terms of computation time, proof size, memory, etc.) are not readily scalable to applications involving large volumes of proofs (e.g., blockchain networks). Verifiable computing approaches have emerged to address the aforementioned verification challenges, each with inherent limitations. Zero-Knowledge Proofs (ZKPs) constitute a cryptographic protocol wherein one party (the prover) can convince another party (the verifier) that a statement is true without revealing any information beyond the validity of the statement itself, but typically require substantial computational resources for complex statements. Zero-Knowledge Succinct Non-Interactive Arguments of Knowledge (zk-SNARKs) represent an advancement wherein the proof is both non-interactive and substantially smaller than the original computation, typically on the order of hundreds of kilobytes regardless of computation complexity. Some embodiments of zk-SNARKS achieve this succinctness through polynomial commitment schemes that encode computational statements as polynomial equations, allowing an entire computation to be committed to using a single, randomly selected group element (thus avoiding proof sizes that scale with computation size). The verifier then examines these commitments at randomly selected evaluation points through bilinear pairings, leveraging the Schwartz-Zippel lemma to ascertain with high probability that the polynomial identity holds globally, thus enabling verification of arbitrarily complex computations using constant-sized proofs. However, traditional zk-SNARKs suffer from a fundamental data type mismatch—while computers operate on bits, bytes, and word-sized units (32 or 64 bits), these protocols compute over large prime fields (typically 256 bits). This creates significant overhead when representing binary operations, as single-bit values (0 or 1) must be embedded in much larger field elements, wasting substantial computational resources and memory. Elliptic curve-based implementations such as Groth16 and PLONK require computationally expensive operations over these large fields, making standard hash functions and bitwise operations expensive to verify. Zero-Knowledge Virtual Machines (ZKVMs) implement a complete instruction set architecture within a zero-knowledge framework, allowing general-purpose computation to be verified, but encounter performance bottlenecks when executing operations that do not align with their underlying field arithmetic, particularly with cryptographic functions like Keccak-256 that are optimized for binary operations rather than prime field computations.

Additional techniques are needed to improve the efficiency of verifiable computing systems, to enable such systems to scale to the verification of large volumes of large computational workloads, while maintaining practical verification times and resource requirements.

### SUMMARY OF THE INVENTION

The present invention provides novel methods and systems for accelerating verifiable computing operations using specialized hardware optimized for binary field arithmetic. By leveraging the inherent compatibility between binary field operations and fundamental digital logic gates (such as XOR and bit-shifts), the invention achieves substantial performance improvements over traditional verifiable computing systems that rely on prime field arithmetic. Binary fields are uniquely suited to hardware acceleration because their operations map directly to the native operations of digital circuits, reducing the computational overhead associated with embedding binary values in larger prime fields. This alignment with hardware primitives enables higher clock frequencies, reduced silicon area requirements, and dramatic reductions in memory and computational time needed to create a proof.

The accelerated binary field operations are particularly advantageous for creating Zero-Knowledge Succinct Non-Interactive Arguments of Knowledge (zk-SNARKs), as they enable efficient implementation of cryptographic primitives like hash functions that previously created significant performance bottlenecks. When applied to SNARK construction, the invention reduces the “embedding overhead” that has historically limited scalability, resulting in orders of magnitude improvements in proof generation speed, significantly lower memory requirements, and drastically reduced verification times. These benefits make the system particularly well-suited for high-volume applications in blockchain technology and other domains requiring computationally intensive cryptographic proofs.

This summary is intended to provide an overview of the subject matter of the present disclosure, and is not intended to identify essential elements or key elements of the subject matter, nor is it intended to be used to determine the scope of the claimed implementations. Its sole purpose is to present some concepts of one or more exemplary aspects in a simplified form as a prelude to the more detailed description that is presented later. The proper scope of the present disclosure may be ascertained from the claims set forth below in view of the detailed description below and the drawings.

### BRIEF DESCRIPTION OF THE DRAWINGS

FIG. 1 illustrates a flowchart for a method for executing mathematical operations on binary tower fields by means of a binary tower field hardware accelerator.

FIG. 2A shows a block diagram of a binary tower field hardware accelerator.

FIG. 2B illustrates interconnections between components of a binary tower field hardware accelerator.

FIG. 3 illustrates an exemplary scenario of register organization in a binary tower field hardware accelerator.

FIG. 4 illustrates a Field Programmable Gate Array that may implement a binary tower field hardware accelerator.

FIG. 5 illustrates a processing element architecture showing multiple execution pipelines configured for mathematical operations.

FIG. 6 illustrates a vector multiplication implementation.

### DETAILED DESCRIPTION

The novel features which are believed to be characteristic of the present invention, as to its structure, organization, use, and method of operation, together with further objectives and advantages thereof, will be better understood from the following discussion.

Some concepts are described in the form of steps of a process or method. In this form, certain operations are described as being performed in a certain order. Such implementations are exemplary and non-limiting. Certain operations described herein can be grouped together and performed in a single operation, certain operations can be broken apart into plural component operations, and certain operations can be performed in an order that differs from that which is described herein, including a parallel manner of performing the operations. The operations can be implemented by software, hardware, firmware, manual processing, and the like, or any combination of these implementations. As used herein, hardware may include computer systems, discrete logic components, such as Field-Programmable Gate Array (FPGA), application-specific integrated circuits (ASICs), and the like, as well as any combinations thereof.

A binary tower field hardware accelerator for verifiable computing is provided herein (and may be referred to as “the accelerator” for brevity throughout the application). The accelerator may perform logical and arithmetic operations on elements defined over binary fields (i.e., a finite field with only two elements, commonly depicted as 0 and 1), or may perform operations defined over a tower of binary fields (as defined below). The accelerator may comprise a plurality of worker agents, where each worker agent may serve as a processing element for performing the operations, and worker agents may work independently of each other. Each worker agent may comprise one or more processing elements, and each processing element may comprise one or more pipelines, each pipeline being configured to execute a subset of instructions supported by the processing element (e.g., a pipeline for loading and storing data, a pipeline for performing arithmetic operations, and/or a pipeline for performing logical operations). Furthermore, worker agents may comprise more than one of each such processing pipeline, and may coordinate work across pipelines according to instructions as described herein.

Worker agents may be connected by means of a network-on-chip construction—i.e., a mesh network of data nodes and configuration nodes that route data, instructions, and other configuration data between worker agents, hosts, and high-bandwidth memory (HBM), as described herein. The network-on-chip construction may comprise two parallel networks that facilitate the copying and/or communication of data between a host, an HBM, and worker agents: a Data Network on Chip (DNoC) and a Configuration Network on Chip (CNoC).

According to one embodiment, the worker agent may be subservient to (i.e., be configured as a “subordinate” or “slave” to) the DNoC and the CNoC. In this configuration, the DNoC may carry data to a worker agent (e.g., vectors of elements defined over binary fields, or a sequence of instructions for the worker agent to perform), and CNoC may carry configuration data to the worker agent (e.g., updates to the control-and-status registers (CSRs) of the worker agent). The worker agent may then execute operations on the data provided by the DNoC (which may include instructions), and per the configuration provided by the CNoC. In this embodiment, the host may be responsible for coordinating the delivery of data and configuration to the worker agents by means of a Direct Memory Access module (DMA). For example, the host may (i) copy, via the DMA, a stream of input data from the host to an address in the HBM, (ii) copy, via the DMA module, the input data from the address to a worker agent, (iii) copy, via the DMA module, output data from the worker agent to HBM, and (iv) copy, via the DMA module, output data from the HBM to the host. The host may communicate with the DMA by means of a compiler or execution environment, which may coordinate data movement dynamically.

The host may communicate with the DMA via any suitable data transmission mechanism that can quickly transfer a large volume of binary field elements to and from the host. The host may communicate with the DMA by means of a data transmission protocol and a data transmission bus. For example, in one embodiment, the host communicates with the DMA based on the AMBA AXI-Stream protocol, developed by Arm Limited, and a PCI-express bus. The accelerator may then comprise a bridge that transfers data between the host, the worker agents, and the HBM by means of the DNoC (i.e., data transfers to/from the host may be routed via the DNoC and a bridge between the DNoC and the host). The DNoC may then be connected to one or more HBM modules by means of additional bridges. In this configuration, the DNoC may be configured as subservient to the DMA. The bridges (i.e., the HBM<->DNoC and Host<->DNoC) may also be configured as subservient to the DMA (i.e., through the DNoC).

In the above configuration, the CNoC may be configured to carry configuration data between the host and worker agents. The configuration data may comprise updates to control-and-status registers (i.e., CSRs) in one or more worker agents. For example, the host may instruct the CNoC to update any of the following CSRs: boot (i.e., to boot up or shut down the WA), instructions byte offset and length (i.e., a reference to instructions stored in the HBM, represented as an offset to a base address), data offset and length (i.e., a reference to data stored in the HBM, typically values defined over towers of binary fields, or vectors thereof), and response offset and length (i.e., a reference to a destination of the HBM to write the data to, and the expected length of response). Other CSRs may also be implemented, based on the specific implementation details; for example, if the worker agent is configured to store results in an on-chip RAM resource, an additional register may indicate the RAM offset at which output data may be stored. The host may communicate with the CNoC by means of a suitable bus standard and communication protocol. For example, the host may connect to the chip (and, more specifically, to the CNoC) by means of a PCI-express connection, and the AXI-Lite communication protocol, or any other communication bus and protocol that supports the organized transmissions of configuration data between the host and the chip. In one embodiment, the accelerator comprises a bridge to mediate data transmission between the host and the chip—e.g., if AXI-Lite is used, a bridge may mediate data transmission between the host and the CNoC described herein (i.e., by “translating” CNoC states to AXI-Lite states, and vice versa).

In alternative embodiments, the manager-subordinate relationships described above may be altered to support a different desired flow of data and instructions. For example, in other embodiments, each worker agent could act as its own DMA master, instructing the DMA (through the DNoC) to store or receive data at addresses that are determined by the worker agent, provided that latency in response from the DMA is handled by the worker agent or elsewhere in the architecture. Alternatively, each individual processing element in a worker agent could operate as a master, possibly with the host (or another component on-chip) providing inputs directly to the worker agent, then relying on the worker agent to request data via the DNoC, or otherwise. A person skilled in the art will recognize a variety of methods to organize the components on-chip, and may consider factors such as chip layout, compiler behavior, latency, simplicity, host capabilities, and/or other factors in configuring the systems and methods described herein to perform according to a desired hierarchy.

In alternative embodiments, the accelerator may be configured to operate on finite fields with a different order, provided that the advantages described herein may be realized (i.e., the unique properties of the finite field may be employed to enable accelerated processing).

A tower of binary fields may be employed to enable the arithmetization of arbitrary data—e.g., a sequence of polynomials—into a binary sequence which may be represented in vector form, and stored in a plurality of registers (e.g., comprised in a worker agent) and/or addressable memory (e.g., in an HBM).

Additionally, certain instructions may be configured to operate on a vector of elements defined over a tower of binary fields. For example, vector multiplication may be performed over a vector of k/n elements, each element being represented as an n-bits value, and the elements being concatenated into a vector of k elements (where k is the word size, e.g. 128 bits, 64 bits, etc.). The output of the multiplication may then be stored in a similar fashion. In some embodiments, mixed vector operations may also be supported—i.e., operations that operate on a vector comprising elements of varying sizes. For example, a mixed vector multiplication instruction may be configured to multiply a first vector of n-bit elements by a second vector of m-bit elements (where n and/or m may be configured at runtime via a CSR or instruction input, at design-time by hardcoding a value for m and n for a given instruction, or elsewhere). In this scenario, the output of the instruction may be stored in a manner determined by m and n; for example, if performing a multiplication of a vector comprising four 32-bit elements by a vector comprising one 128-bit element, four outputs of 128 bits each may be stored at a predetermined sequence of four registers. Support for operating on elements of different sizes enables the accelerator to perform mixed-precision matrix multiplication operations, while maintaining a structured access pattern to the register file.

Cryptographic computations may occur by means of worker agents, which may each comprise one or more processing elements. In one embodiment, worker agents may implement a four-pipeline architecture comprising four execution pipelines: two input/output pipelines for data movement, an arithmetic pipeline for logical and arithmetic operations, and a multiplication pipeline (MUL). Each pipeline may operate in parallel, and may have shared access to shared resources of the worker agent (e.g., a shared register file and RAM). Certain resources may be shared across pipelines. For example, in one embodiment, a combinational logic block may be placed between a register file and an execution pipeline, and may direct input data to the pipelines based on the instruction stream. An additional combinational logic block may be placed after the execution pipeline may be placed after the execution pipeline and may direct output data to the register file. This pipelining approach enables maximal utilization of resources, and also serves to improve chip layout and manufacturability concerns. For example, an instruction that must simultaneously read/write data from a plurality of registers (e.g., the bit-collect operator discussed infra) may require a large volume of wires on-chip, which may contribute to a complex chip layout. These wires may be shared with other instructions by means of the approach described herein.

IA cryptographic NoC architecture may utilize a dual-network approach, where a Data NoC (DNoC) may handle operational data through a 2D mesh of interconnected nodes, and a Configuration NoC (CNoC) may manage and setup operations through a parallel 2D mesh network. Each DNoC and CNoC may be associated with one or more worker agents, and the worker agents may be subservient to the DNoC and CNoC.

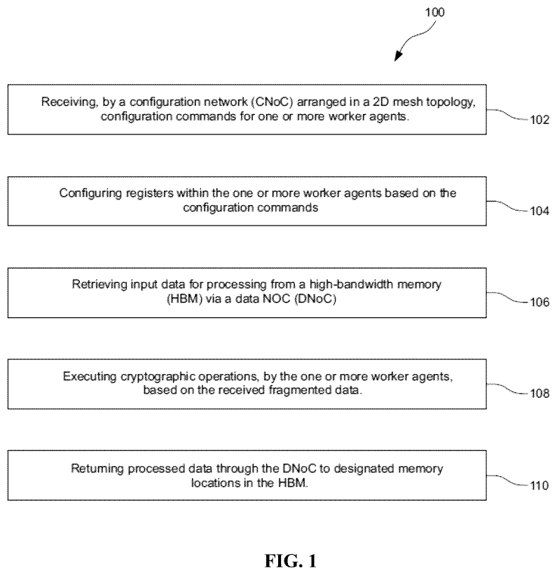

FIG. 1 illustrates a flowchart for method 100 for executing cryptographic computations on the accelerator.

In an exemplary embodiment, method 100 may include a step 102 of receiving, by a configuration network-on-ship (CNoC), configuration data for one or more worker agents. The CNoC may comprise a plurality of configuration nodes, arranged in a two-dimensional mesh on the chip. Configuration data may be received from a host for configuring control-and-status registers of worker agents. A host may send data to the CNoC through a host-to-chip interface, such as through a bus that adheres to the Peripheral Component Interconnect Express (PCI-express) standard, or another appropriate protocol or standard known to those skilled in the art. The CNoC may comprise, or be accompanied by, a bridge to mediate communications between the CNoC and the host. For example, the bridge may convert transmissions from a first protocol to a second protocol, where the first protocol is employed for communications between the chip and the host, and the second protocol is employed for communications between components on the chip. In one embodiment, the AXI-Lite (AXIL) protocol is used for communications between the host and the chip, and an AXIL<->CNoC bridge serves to direct configuration data transferred via AXIL to and from the CNoC (via the protocol expected by the CNoC).

In an exemplary embodiment, method 100 may further comprise step 104, which may comprise configuring registers within the one or more worker agents based on the configuration data. For example, CSR registers discussed above may be written to a plurality of worker agents, per the configuration data sent by the host.

In an exemplary embodiment, method 100 may include step 106 of retrieving input data for processing from a high-bandwidth memory (HBM). The input data may comprise a stream of instructions and a stream of elements (or vectors of elements). The input data may be made available to the worker agent through a variety of means, depending on the relationship between the worker agent and other components in the application. In a first embodiment, the worker agent is subservient to the DNoC/CNoC (which is, in turn, subservient to the DMA). In this embodiment, the host may instruct the DMA module to transfer instructions and data from the HBM to the worker agent RAM, via the DNoC. Then, the host may then update the “boot” flag on the worker agent, via the CNoC, once the instructions and data have been transferred. The worker agent may then process the input data by means of the pipelines discussed above. An instruction counter may be employed for the worker agent to advance through the stream of instructions. Additionally, instructions may be specified as very long instruction words (VLIW) such that pipelines in the worker agent may be executed in parallel. Notably, worker agents may work independently—i.e., a plurality of worker agents in the accelerator may operate in parallel on different data, and outputs from a first worker agent may be used as inputs to a second worker agent. In one embodiment, this is coordinated by the host (i.e., by compiling a complex program, which may comprise pre-configured subroutines, into a series of worker agent instructions and/or DMA commands, and then executing said instructions and DMA commands on the accelerator). However, in other embodiments, the worker agents may be self-coordinating—i.e., one worker agent may serve as a master to a plurality of other worker agents, and may perform actions to facilitate a computation (e.g., instructing the DMA to load and store data).

In an exemplary embodiment, retrieving the input data for processing may include fragmenting data packets of the input data into Flow Control Units (FLITs), and routing the FLITs through the DNoC to the respective worker agents. Fragmentation may be performed by a bridge. For example, the DNoC<->HBM bridge may fragment data retrieved from the HBM into a plurality of FLITs, which may then be received and processed by the worker agent. In alternative embodiments, fragmentation may be performed by a separate module on the chip, by the host, or may be contained within any other module described in this disclosure. The DNoC may be configured to support a variety of FLIT types, signified by a type header. For example, FLIT types may include Head flits, Data flits, and DataTail flits (where Head flits signify the start of a packet, a plurality of Data flits contain the content of the packet, and the DataTail flit signifies the end of the packet). FLITs may also contain destination values—such as the identifier of a worker agent, a HBM bridge, a DNoC<->HBM bridge, or the host. After data is fragmented into FLITs, FLITs may be transported through the DNoC using an on-chip communication protocol that enables the efficient movement of large volumes of data. For example, the AXI4-Stream interface provided by Arm Limited may enable the transmission of a stream of FLITs across components on-chip. In one embodiment, FLITs may be configured to correspond with physical units (i.e., phits) that represent the width of communication means implemented on the DNoC (e.g., on-chip communication buses).

Method 100 may include a step 108 of executing cryptographic operations, by the one or more worker agents, based on the received input data. Executing cryptographic operations may involve instructing the respective pipelines of each of the one or more worker agents to perform operations on a plurality of values defined over finite fields. For example, the worker agents may be configured to receive a plurality of instructions to perform specified operations on one or more values, and such instructions may be designed according to the SIMD technique. According to one embodiment, worker agents may be configured to accept bitwise logical instructions (e.g., AND, XOR, and bitwise shifts), data movement instructions (e.g., converting bit-sliced data layouts into bytes via a bit collect operation, performing an element-wise transpose operation on registers, or loading/storing single, double, or quad-words from the processing element local data memory), and multiplier instructions (e.g., multiplying values, multiplying and accumulating values, performing vector multiplication, and/or performing vector multiplication on value of mixed sizes). In an exemplary embodiment, there may be a plurality of logical pipelines that may be independently controlled to perform such operations in each worker agent; for example, a worker agent may comprise one or more load-store pipelines (LSUs), one or more arithmetic logic unit pipelines (ALUs), and/or one or more multiplier pipelines (MULs). The pipelines may be configured to operate on vectors of elements, thus enabling the execution of a plurality of desired computations in each clock cycle; this configuration is particularly desirable when a large number of computations must be performed to achieve a desired result (e.g., a plurality of polynomial evaluations may be performed to compute a zero-knowledge proof). Furthermore, the pipelines may be configured to operate on vectors of element size n and word size k (where k/n elements are present in each word); the value n may be configured at design-time (e.g., by flashing firmware that contains logic units that operate on elements of size n), or at execution-time (e.g., by routing operations to an appropriate logic unit based on an n value configured in a CSR).

In an exemplary embodiment, the pipelines may be configured to operate on values defined over finite fields—or, coefficients of multinomials defined over towers of finite fields. In one embodiment, the pipelines are configured to operate on values defined over a tower of binary field extensions—i.e., a tower of recursive extensions, starting with the binary field F₂ (i.e., where a binary field is a finite field of order 2). These values may be represented as a bitstream of coefficients of multilinear polynomials defined over the tower of binary field extensions. For example, the binary field F₂ is a field with two possible elements (0 and 1). An extension of the binary field may be added by defining x₀, where x₀²=x₀+1, and then representing multiplies of x₀ as an additional bit in the bitstream; an arbitrary additional xᵢ may be defined in this manner, giving rise to a tower construction represented as a bitstream. A plurality of such bitstreams may be made available to the worker agent for operations. The nature of binary fields gives rise to efficient hardware implementations of common operations. An element of the field F₂^{k} may be represented simply as a bitstream of length k, and additions of two such elements may be accomplished by means of the XOR operation. Multiplication may also be implemented efficiently, such as via the Karatsuba methodology discussed herein. This property of binary fields, applied to the novel accelerator infrastructure disclosed herein, gives rise to impressive efficiency improvements; for example, a 32-bit binary tower multiplier implemented on a 14 nm process node may perform single-clock operations at up to 1.4 GHz, using 748 μm² of silicon area (compared to 0.5 GHz, and 1,357 μm² of silicon area, for operations on the Mersenne31 prime field).

Method 100 may include a step 110 of returning result data through the DNoC to designated memory locations in the HBM.

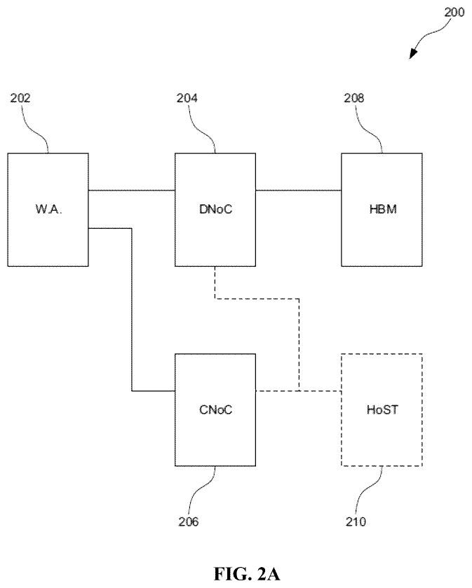

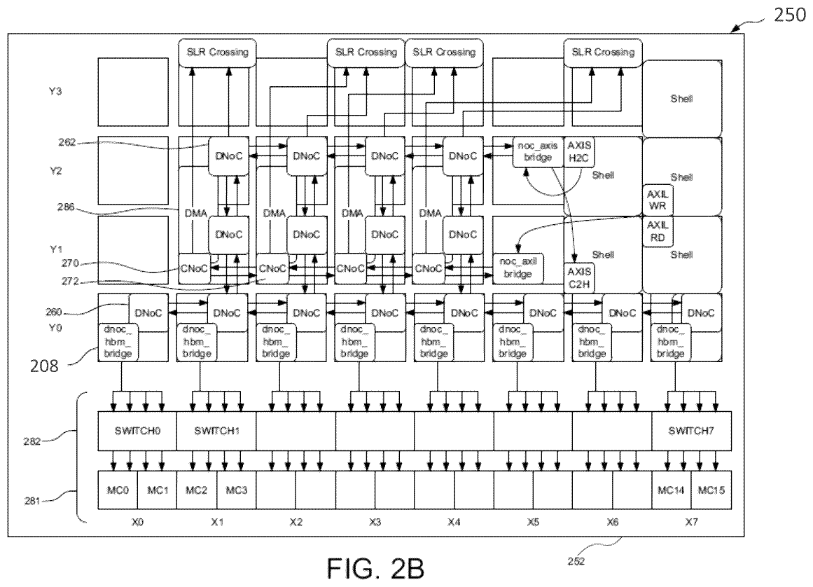

In an exemplary embodiment, after each worker agent processes the received fragmented data, result data may be returned to designated memory locations in an HBM, such as HBM 208 (shown in FIG. 2A). The worker agent may first store result data in RAM that is comprised within the worker agent (e.g., by means of the LSU pipeline, in response to a store instruction in the instruction stream). Then, the host may instruct the DMA module to transfer the data from the WA to the HBM (through the DNoC and the DNoC< >HBM bridges).

FIG. 2A illustrates a block diagram of a cryptographic NoC architecture 200. In an exemplary embodiment, cryptographic NoC architecture 200 may include worker agents (WA) 202, DNoC 204, CNoC 206, HBM 208, and DMA 286 (shown in FIG. 2B) each of which will be discussed in turn.

In an exemplary embodiment, each respective worker agent may include at least one processing element configured to perform mathematical operations on values defined over a binary tower field. The processing element(s) may be referred to as specialized processing units, finite field processing units, or cryptographic processing units, and may comprise processing elements for executing cryptographic operations, such as operations for verifiable computing operations. The specialized processing element may take advantage of the mathematical properties of finite fields to accelerate the computations described herein; for example, when performing operations on elements defined over a binary field, arithmetic operations may be performed using only a plurality of simple logic gates, rather than complex multiplier cores (which may utilize additional space on a chip, and thus limit the computational throughput available on a chip). Multipliers may be implemented by means of a plurality of simple logic gates (and recursive constructions, as defined below, may improve the efficiency of multiplication operations).

In an exemplary embodiment, each worker agent of worker agents 202 may comprise local memory resources for temporary data storage and computations (e.g., Random Access Memory, or RAM), interface logic for communication with the DNoC 204 and the CNoC 206, registers for various purposes (e.g., CSRs for configuration, general purposes registers for computation, instruction registers for maintaining a reference to instructions stored in memory, etc.), and logic for accelerating calculations (i.e., one or more accelerator cores). The local memory resources may be optimized to enable synchronous and/or high-speed access by the worker agent. In an exemplary embodiment, the local memory resource may be implemented as memory blocks that are included in, or attached to, the worker agent. Local memory blocks may be implemented by a variety of means known to those skilled in the art (e.g. UltraRAM blocks as developed by Arm Limited). Local memory resources and registers may be assigned to a specific worker agent, and/or shared among worker agents (which may enable efficient pipelining of results from one worker agent to another to further accelerate computation). As described above, in some embodiments, the worker agent may be configured as a “subordinate” component to a “manager” component; for example, the worker agent may be configured as a “subordinate” or “slave” to a DNoC 204 and/or CNoC 206 (thus allowing the DNoC 204 and/or CNoC 206 to control the operation of the worker agent; or, the host to control the worker agent through the DNoC/CNoC).

In an exemplary embodiment, the DNoC 204 may operate as a 2D-mesh of interconnected data notes in a first logic region as discussed in further detail below, facilitating efficient data routing between HBM 208 and the worker agents 202. Each node within DNoC 204 may be connected to up to four neighboring nodes (North, South, East, and West). Data may be routed between data nodes within DNoC 204 utilizing the X-Y routing algorithm; that is, packets may be routed in the east-west direction until reaching the same column as the destination data node, and then may be routed along the north-south direction until reaching the destination data node. The packets may then be routed to the worker agent connected to the data node. A plurality of worker agents may be connected to a data node, and traffic may be balanced among the worker agents to enable higher throughput. A flow control unit (FLIT) may be routed through nodes of DNoC 204 until it reaches a respective node that is mapped to a respective worker agent that the FLIT is destined for (based on a destination header contained in the FLIT). Packets addressed to a respective worker agent may receive a response from the worker agent; i.e., packet routing may be round trip. Data nodes may be connected to each other, and connected components (e.g., bridges), via on-chip wires and/or an on-chip communication protocol (e.g., AXI Stream). Further details regarding DNoC communication and DNoC protocols are provided in further detail below.

In an exemplary embodiment, CNoC 206 may operate as a 2D-mesh of interconnected control data nodes, facilitating the configuration of respective worker agents by routing control data to respective worker agents. CNoC 206 may allow for a host to configure the worker agents 202 to operate as desired by writing to Control-and-Status Registers (CSR) in each respective worker agent. The worker agents may also support a plurality of additional utilities, such as utilities that provide advanced access to the chip. For example, an interrupt table may allow for the configuration of a register that instructs the worker agent to immediately stop a pending computation and jump to an interrupt handler. In addition, a cross-trigger system may enable the synchronous debugging of a plurality of cores—by synchronizing work across the cores, and stopping all cores if a breakpoint is reached on one core.

In an exemplary embodiment, a high-bandwidth memory module (HBM 208) is illustrated in FIG. 2A may serve as a central memory unit of the accelerator. The high-bandwidth memory module may comprise a plurality of memory controllers, and bridges between memory controllers and the DNoC (i.e., DNoC<->HBM bridges). The bridges may mediate communication between the DNoC and the HBM; for example, by accepting packets in the DNoC protocol (e.g., flits) and converting those packets into signals for the HBM to respond to (e.g., storing or loading data at a particular address). The bridges may connect to memory controllers via a switch, such that each bridge can access all microcontrollers. A bridge may be located “south” of each DNoC, such that a DNoC may route a packet to the HBM by simply routing south until the bridge is reached. In one embodiment, the HBM is an AXI High Bandwidth Memory Controller developed by Arm Limited.

In an exemplary embodiment, the accelerator may be implemented on a Field Programmable Gate Array (FPGA). The following description of the FPGA embodiment is intended to depict how the various components described in this disclosure may be organized on-chip. However, this description is not exclusive, and a different organization of components may be preferred to satisfy requirements for a particular embodiment of the invention (e.g., layout constraints).

In one embodiment, the control and data planes of the accelerator—i.e., the DNoC 204, Direct Memory Access (DMA), and bridge modules—may be implemented in a first chiplet (which, in some embodiments, may be referred to as a super logical region). Worker agents may reside in a second chiplet, which may be a computation region. Since each respective worker agent of worker agents 202 includes specialized processing units, SLR1 may enable distributed parallel processes of cryptographic computations across a plurality of worker agents. In one embodiment, up to 64 worker agents may be embedded on SLR1, and connected to DNoC and CNoC elements via die-to-die crossings that comprise on-chip communication buses. For example, worker agents may be connected to DNoC nodes via AXI4 subordinate ports, and worker agents may be connected to CNoC nodes via AXI-Lite (AXIL) subordinate ports. On the FPGA, this implementation may be supported by means of a silicon interposer to bridge the chiplets. The particular configuration of worker agents, DNoC, and CNoC cores may differ according to the desired performance characteristics of the cryptographic NoC architecture; for example, a particular FPGA may only be able to accommodate a certain number of logic blocks according to the height and width of the chip, and the configuration of worker agents may be adjusted to meet the design requirements of the FPGA.

FIG. 2B illustrates interconnections between components of a binary tower field hardware accelerator. In detail, FIG. 2B illustrates scenario 250, with a schematic of a first logic region with various components illustrated.

A plurality of DNoC nodes, such as nodes 260 and 262 are illustrated. Each respective node may be associated with one or more respective worker agents. Each DNoC node may be part of a DNoC which may allow transfer of computational data between exemplary HBM and exemplary worker agents, as described above.

A plurality of CNoC nodes, such as nodes 270 and 272 are illustrated. Each respective CNoC node may be associated with one or more respective worker agents. Each CNoC node may be part of CNoC which may allow transfer of configuration data/instructions between the host and worker agents.

There may be a plurality of DNoC to HBM bridges, such as bridge 208, which may allow the movement of computational data between an HBM and DNoC. For example, a DNoC to HBM bridge may connect the DNoC to a plurality of HBM memory controllers through switches 282, which may enable the DNoC to access a large amount of memory (e.g., 16 GB of memory) per memory controller 281. The bridge may be stateful, and may route egress packets (e.g., loaded memory) back to the source of ingress packets.

In an exemplary embodiment, a first logic region may further include Direct Memory Access (DMA) modules, such as DMA 286. DMA 286 may enable the efficient movement, loading, and/or storage of data between an HBM, worker agent, or host. For example, the host may retrieve a first set of data from the HBM, and the DMA module may transfer the data from the HBM to an interface accessible to the host (or vice versa—i.e., the DMA module may transfer data from the host to the HBM). For example, the host may instruct the DMA to store a vector of n-bit values defined over finite fields, where the values comprise or represent computations to be performed for a cryptographic operation (e.g., the construction of a zk-SNARK). Additionally or alternatively, the DMA module may enable the transfer of data between the HBM and worker agents; for example, the DMA module may be instructed, by the host, to store the results of computations performed by the worker agent in HBM, for later retrieval by the host.

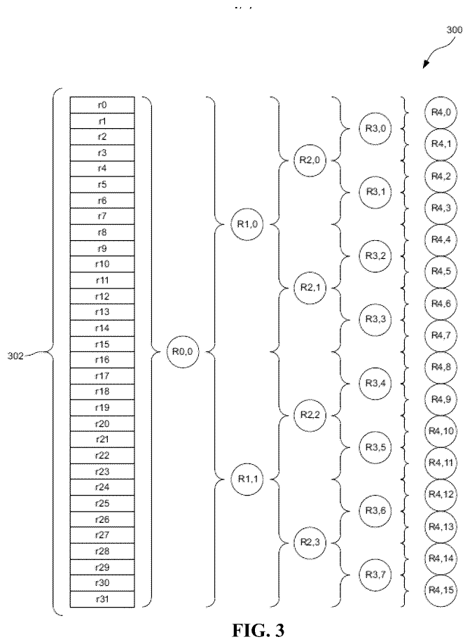

FIG. 3 illustrates an exemplary scenario 300 of a register organization within a worker agent. In this embodiment, thirty-two general purpose registers 302 may be configured in various modes to support a variety of element sizes. For example, a register may comprise space for sixteen separate data elements stored in vector form. Alternatively, the same registers may be configured to handle fewer, larger elements in each register when the worker agent is configured to operate on larger element sizes. The register may be configured to accommodate elements of mixed size (e.g., a combination of 8-bit, 16-bit, 32-bit, or larger values), and the worker agents may be configured to perform operations on such mixed elements (thus avoiding unnecessary calculations for elements of mixed precision).

For example, in FIG. 3, registers 302 comprise 32 general-purpose 128-bit registers. Register assignments for mixed multiplications operations may follow a hierarchical structure, where register R1,1 represents sixteen outputs for 8-bit operations, registers R2,2, and R2,3 represent eight outputs for 16-bit operations, registers R3,4 through R3,7 represent four outputs for 32-bit operations, and registers R4,8 through R4,15 represent two outputs for 64-bit operations. This example assumes a 128-bit word size.

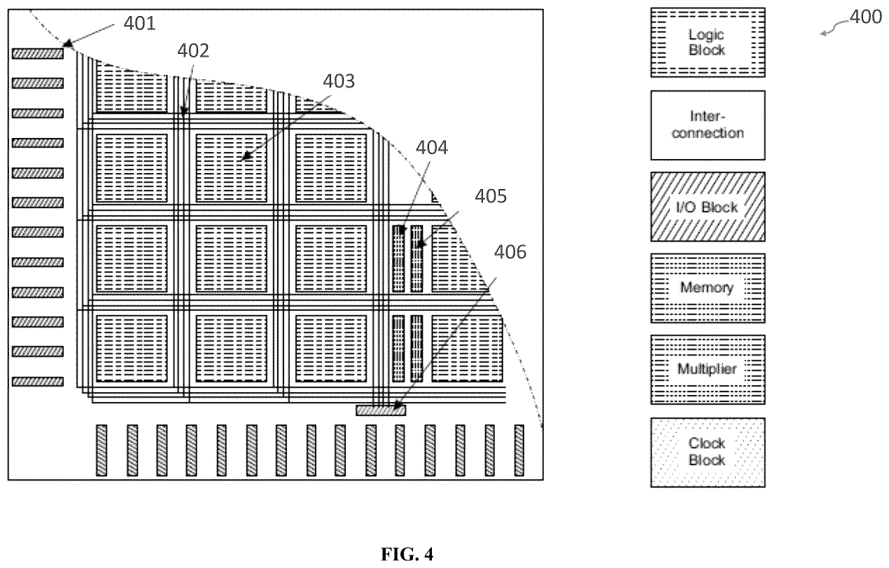

FIG. 4 illustrates the architecture 400 of an exemplary Field Programmable Gate Array (FPGA) configured to accelerate binary field operations for verifiable computing applications. An FPGA is a semiconductor device composed of a matrix of configurable logic blocks connected via programmable interconnects, allowing the hardware to be configured after manufacturing to implement custom digital circuits. The FPGA may be configured to implement the systems and methods described herein, and we briefly describe methods for doing so herein. It is important to note, however, that the methods and systems herein are not limited to implementation on an FPGA. Rather, one skilled in the art will recognize numerous alternative means of implementation (including, but not limited to, the creation of an Application Specific Integrated Chip (ASIC)).

The FPGA may comprise Input/Output Blocks (IOBs), shown at positions 401, which serve as the interface between the internal circuitry and external devices. These IOBs manage data transfer with host systems, external (i.e., off-chip) memory, and other external components. Each IOB includes configurable drivers, voltage level translators, and optional serialization/deserialization (SerDes) functionality to accommodate various communication protocols such as PCIe, Ethernet, or custom interfaces optimized for binary field data transfer.

The routing matrix, depicted as the interconnection grid at position 402, may form the communication infrastructure that connects all elements within the FPGA. This programmable network enables signals to be routed between any two points on the device according to the implemented design. For binary field operations, the routing matrix may be configured to optimize data flow between worker agents, DNoC/CNoC nodes, and other components described herein. This configuration may minimize latency and maximize throughput for critical computation paths. For example, worker agents may be comprised in a first SLR, and a mesh of DNoC/DNoC nodes may be comprised in a second SLR, where the SLRs are connected by means of a passive silicon interposer.

Shown at position 403, the Configurable Logic Blocks constitute the primary computational resource of the FPGA. Each CLB contains look-up tables (LUTs), multiplexers, and flip-flops that can be programmed to implement arbitrary Boolean functions. For binary field acceleration, these CLBs are configured to efficiently perform operations such as bitwise XOR, polynomial multiplication, and bit shifts that are fundamental to binary field arithmetic. The CLB configuration exploits the natural alignment between binary field operations and the underlying boolean logic operations that FPGAs execute natively. FPGAs may also comprise dedicated blocks that perform specific operations, such as multiplier blocks 405 or blocks for digital signal processing (DSP), that may be configured to perform the methods described herein.

Position 404 indicates the High Bandwidth Memory module of an FPGA, which provides high-speed, high-capacity on-chip memory resources. HBM employs stacked memory dies connected to the FPGA through a silicon interposer, delivering substantially higher bandwidth and lower latency than traditional external memory interfaces. This architecture is particularly advantageous for binary field operations in verifiable computing, as it enables the storage of a large number of polynomial coefficients and intermediate results without the bandwidth limitations of conventional memory systems.

Position 406 depicts the Clock Management Tiles, which generate, distribute, and control the clock signals throughout the FPGA. The CMTs may be configured to support multiple clock domains, allowing different components of the verifiable computing pipeline to operate at different frequencies.

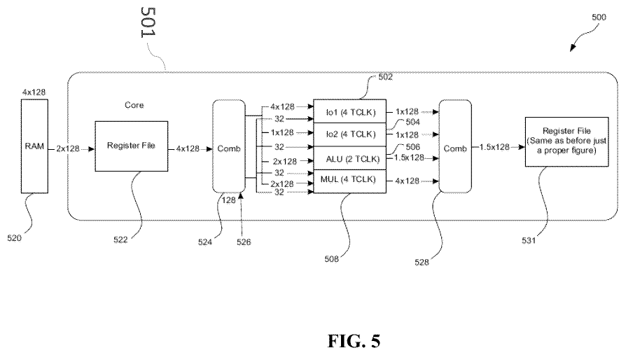

FIG. 5 illustrates a processing element architecture 500 showing multiple execution pipelines configured for mathematical operations. The processing element architecture 500 includes a RAM 520, and a core 501 that includes a set of register files 522, and 531, and a set of combination logics 524, and 528. The RAM 520 is configured to provide data to the core 501. The register file 522 may configured to store data received from the RAM 520. The combination logics 524 is configured to pre-process this data. The configuration process may select one or more pipelines to execute in a given clock cycle through a series of register updates. In an exemplary embodiment, four pipelines may entail Input/Output 1 (IO1) 502, Input/Output (IO2) pipelines 504, ALU pipeline 506, and Multipliers (MUL) pipeline 508.

ALU pipeline 506 may be configured to perform a plurality of operations according to instructions received by the worker agent. In an exemplary embodiment, an exemplary ALU pipeline 506 may perform logical operations, such as AND2/AND3 (an ‘and’ operation on three inputs), XOR2/XOR3 (an ‘xor’ input on two or three inputs, which may implement addition in the context of binary fields), and SRL/SLL (left and right bitwise shifts, based on an immediate value).

MUL pipeline 508 may be configured to perform a plurality of operations, according to instructions received by the worker agent. For example, a Bit Collect (BITC) instruction may convert bit-sliced data into byte format by accepting a destination register, a start source register, and an immediate value representing the index of the first bit index in the destination register. The BITC instruction may then collect bits stored in a plurality of registers (e.g., 8 registers) and may concatenate those bits in the destination register in byte format, thus making the bytes available for operation by subsequent operators (e.g., vector multipliers). A Transpose (TRAN) instruction may perform an element-wise transpose on a 128/n×128/n matrix stored in 128/n registers (where n is the element size, and maybe 8, 16, 32, or 64 in some embodiments); this operation may simultaneously read and write to 128/n registers to perform the transpose. Outputs of these four pipelines are gathered by another combination logic 528. Further, the register file 531 may be configured to temporarily store the data received from the combination logic 528 before it is used.

Operations may be configured to operate on values defined over finite fields, or towers thereof—e.g., the bitstream of coefficients discussed above. Furthermore, vector processing operations may comprise configuring registers to process one of sixteen 8-bit elements in parallel, eight 16-bit elements in parallel, four 32-bit elements in parallel, and/or two 64-bit elements in parallel (assuming a 128-bit word size; other word sizes, and thus other representations of vectors, are anticipated). Such configuration may occur by means of updating CSRs via the CNoC, or by providing element sizes as an instruction input. The execution of operations may occur simultaneously across all elements by means of independent execution paths.

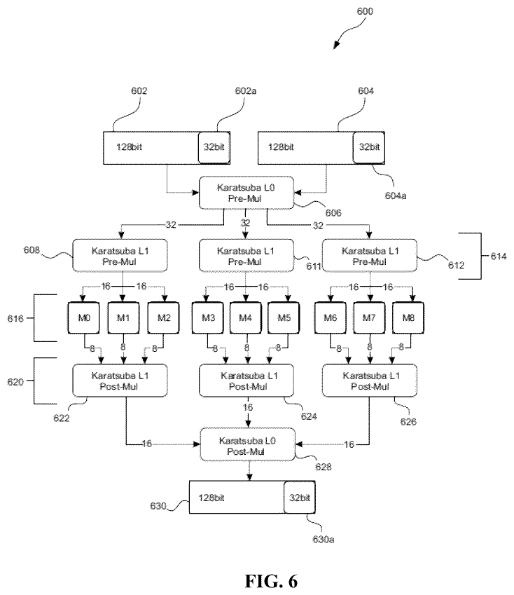

FIG. 6 illustrates a multiplication implementation, consistent with one or more exemplary embodiments of the present disclosure. In detail, in an exemplary embodiment, flow chart 600 illustrates implementation of a Karatsuba multiplication algorithm. The Karatsuba multiplication algorithm 606 or 628 may allow for recursively breaking down a complex multiplication over a large value—e.g., a 128-bit*128-bit multiplication (602, and 604)—into a plurality of simpler multiplications over smaller values such as 32-bit (602a, and 604a). A multiplication 614 (608, 611, 612) performed on an element of size n may be broken into three child multiplications 616 on elements of size n/2; and this may be broken down recursively, in hardware, until the leaf multiplier is reached. The child multiplications 616 may be performed in parallel, and then aggregated together. The leaves 620 (622, 624, 626) of this configuration may be implemented as a plurality of 8-bit by 8-bit multipliers, 4-bit by 4-bit multipliers, or similar base cases (630, and 630a). A plurality of base multipliers may enable a plurality of operation modes. For example, assuming base multipliers perform 8-bit by 8-bit multiplications, 81 base multipliers may enable a 128 bit×128 bit multiplier, a subset of those multipliers may be employed to enable multipliers for smaller values (e.g., 54 multipliers may enable a 64*64 bit multiplication). A MUX unit may be employed to optimize the use of multipliers according to the instructions that are run in a given clock cycle; for example, if the worker agent comprises 81 multipliers and the worker agent has been instructed (through the CNoC) to multiply three 16 bit*16 bit values (where each 16 bit*16 bit multiplication employs 16 base multipliers), the three multiplications may be performed in parallel using the base multipliers on board. The usage of multipliers may be altered dynamically based on the instructions provided to the worker agent.

Likewise, the base multipliers may also enable vector multiplication, in addition to simple multiplication. For example, 192 base multipliers may enable the implementation of an embodiment of vector multiplication that multiplies a vector of 8 16 bit elements (i.e., stored in a 128 bit word) by a 128 bit element. The 192 multipliers are employed as follows: 3 multipliers are used for each 16-bit*16-bit multiplication; the 128 bit element is broken into 8 16-bit segments; and the 8 16-bit segments are each multiplied by the 8 16-bit elements, thereby requiring 3*8*8=192 total multipliers to execute the vector mixed multiplication. A variety of base multiplier configurations may be employed to support multiplications of different sizes (e.g., 8 bit*128 bit, 32 bit*128 bit, etc.).

The multiplication implementation described above may be employed to execute operations on operands of different width. For example, a MUL instruction may be defined to perform 128 bit*128 bit multiplication over two registers, and store the result in a third register; the instruction may be implemented to perform said operation on finite fields (such as binary fields). A VMUL instruction may be defined to treat a register as a vector of k/n n-bit elements, where k is the word size, and then may perform element-wise multiplication of the vectors via a series of multipliers. Likewise, a VMMUL instruction may be defined to perform vector multiplication on multiple inputs of different sizes (such as multiplying a vector of 8 bit values by a vector of 32 bit values), provided that the instruction is configured to store the output values in an appropriate number of registers based on the input sizes. A configurable pack of base multipliers (or constructions thereof, such as the recursive multipliers described herein) may be employed to enable a variety of configurations, without requiring changes to the underlying hardware. The same hardware may be employed to perform multiple operations during the same clock cycle—i.e., by allocating operations to base multipliers that are available for operations on large operands, but which are otherwise unused for operations on small operations. This configuration may be achieved by a variety of means—such as by configuring a control register to select a particular configuration, accepting operand sizes in a VLIW instruction, and/or directing signals to appropriate logic gates by means of a multiplexer or other logical operation.

In an exemplary embodiment, a compiler may compile a list of polynomial evaluations into a binary instruction stream on a specialized processing unit within an exemplary worker agent. In an exemplary embodiment, a compiler may compile a plurality of subroutines together that represent computations for verifiable computing. For example, subroutines may allow the computation of a sumcheck operation for a zero-knowledge proof (where a sumcheck operation enables a prover to demonstrate the correctness of a polynomial's sum evaluated over all possible binary inputs, and the verifier to verify the proof without re-performing the computation).

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed:

1. A method for executing verifiable computing operations on a binary tower field hardware accelerator, the method comprising:
receiving, through a configuration network, configuration for one or more worker agents;
receiving, through a data network, one or more elements, the elements being defined over a small element field;
executing, by the worker agents, one or more mathematical operations involving the elements.

2. The method of claim 1, further comprising generating a proof to be used in a verifiable computing protocol.

3. The method of claim 1, wherein the set of mathematical operations comprises a multiplication instruction, the multiplication instruction being implemented by means of recursive recomposition.

4. The method of claim 1, wherein the data network comprises a two-dimensional mesh of data nodes.

5. A binary tower field hardware accelerator for verifiable computing, comprising:
one or more worker agents, each worker agent being configured to perform mathematical operations in a finite field;
one or more data nodes, the data nodes being configured to route elements to the worker agents;
one or more configuration nodes, the configuration nodes being configured to route configuration to the worker agents; and
a high-bandwidth memory module.

6. The binary tower field hardware accelerator of claim 5, wherein the accelerator generates a proof to be used in a verifiable computing protocol.

7. The binary tower field hardware accelerator of claim 5, wherein the accelerator comprises a field-programmable gate array.

8. The binary tower field hardware accelerator of claim 5, wherein the data nodes are organized in a multi-dimensional mesh, and data is transmitted between data nodes according to a routing algorithm.

9. The binary tower field hardware accelerator of claim 8, where the routing algorithm is a turn restriction routing algorithm.
